(19) United States
(12) Patent Application Publication
(10) Pub. No.: US 2012/0123863 A1
(43) Pub. Date: May 17, 2012

(54) Keyword publication for use in online advertising

(76) Inventors: Rohit Kaul, Mountain View, CA (US); David Tao, Sunnyvale, CA (US)

(21) Appl. No.: 13/136,210

(22) Filed: Jul. 26, 2011

Related U.S. Application Data
(60) Provisional application No. 61/456,771, filed on Nov. 13, 2010.

(51) Int. Cl. G06Q 30/00

(52) U.S. Cl. 705/14.52

(57) ABSTRACT

In a technique for publishing keywords for use in an online advertising system (OAS), keywords are extracted from product information that is received from entities that provide products. Based on calculated performance metrics associated with the extracted keywords, an estimated viability of the keywords (such as an estimated profitability) when used in the OAS is determined and a subset of the keywords is selected. Then, the selected subset of the keywords is published to the OAS. For example, the selected keywords may be bid on for use in search-engine-based online-advertising campaigns. Note that the performance metrics for a given keyword may include: a performance metric that is independent of the product information, a performance metric that is based on the product information, and/or an OAS performance metric.

### CROSS REFERENCE TO RELATED APPLICATIONS

This application claims priority under 35 U.S.C. 119(e) to U.S. Provisional Application Ser. No. 61/456,771, “Keyword Publication for use in Online Advertising,” by Rohit Kaul and David Tao, filed on Nov. 13, 2010, the contents of which are herein incorporated by reference.

### BACKGROUND

The present disclosure relates to techniques for publishing keywords for use in an online advertising system (OAS).

Search engines are increasingly popular tools for providing users information, such as documents or links to web pages, in response to user-provided search queries. These search queries typically include keywords, which are often used by search engines to identify and display associated advertising to users (so-called ‘paid search results’). Furthermore, the paid search results are often ordered or ranked based on factors, such as: the performance of a particular advertising link (for example, based on its relative click through rate), the amount of money or the ‘bid amount’ paid by an advertiser to associate a keyword with the advertising, text that accompanies an advertisement (so-called ‘ad-copy’), etc. In general, an online advertiser can obtain a higher position in the paid search ranking by offering a larger bid amount for a given keyword.

One type of online advertiser includes e-commerce web pages or websites. These websites usually have an associated product catalog (which is sometimes referred to as a ‘feed’) that contains product information (such as a product description, title, image, price etc.), which is typically frequently refreshed as dictated by business needs. To facilitate identification of products on such e-commerce websites, comparison-shopping websites (which are sometimes referred to as ‘comparison-shopping engines’) routinely collect or aggregate the product information in these product catalogs from individual e-commerce websites or businesses, and merge them to produce a comparison-shopping search index. Users can leverage this comparison-shopping search index to obtain multiple offers for a desired product, as well as to identify multiple products in response to a keyword-based query.

In order to help drive users to a given e-commerce website or a comparison-shopping website, bid amounts may be placed on keywords on search engines so that an advertisement associated with the given e-commerce website or the comparison-shopping website appears in the paid search results displayed on a search-engine web page in response to search queries that include one or more of the keywords. Then, when a user activates a link associated with such an advertisement, the user may be redirected to the given e-commerce website or a comparison-shopping website.

As a consequence, selecting the correct keywords and determining the appropriate bid amounts can be very important in implementing a successful online advertising campaign. Furthermore, given the strong competition and narrow margins that are often associated with electronic commerce, these operations can have a strong impact on the profitability of the e-commerce websites and the comparison-shopping websites. However, the complex and dynamic nature of online networks, such as the Internet, have made it very difficult to evaluate keywords and the associated bid amounts, which can significantly complicate online advertising campaigns, as well as the successful operation of comparison-shopping websites and e-commerce websites.

### SUMMARY

The disclosed embodiments relate to a system that publishes keywords for use in an online advertising system (OAS). During operation, the system receives product information from entities that provide products, and extracts keywords from the received product information. Then, the system calculates one or more performance metrics associated with the extracted keywords. The performance metrics for a given keyword may include: a performance metric that is independent of the product information, a performance metric that is based on the product information, and/or an OAS performance metric. Next, the system selects a subset of the keywords based on an estimated viability of the keywords when used in the OAS (such as an estimated profitability), where the estimated viability is determined using the calculated performance metrics. Moreover, the system publishes the selected subset of the keywords to the OAS.

In some embodiments, ‘publishing’ the selected subset of the keywords may involve additional operations. For example, publishing the selected subset of the keywords may involve bidding to be associated with the keywords in paid search results that are generated by a search engine in response to user search queries. Alternatively or additionally, publishing the selected subset of the keywords may involve aggregating groups of keywords in the selected subset. In these embodiments, a given group of keywords may have a common product classification and a common construction template, which can be used to generate advertising text associated with a given keyword in the given group of keywords based on the construction template and one or more attributes associated with the given keyword. Note that at least one of the keywords may be assigned to multiple groups of keywords (in general, the given keyword is assigned to at least one of the groups of keywords). Furthermore, at least one of the keywords may be dynamically reassigned from a group of keywords to another group of keywords based on a quality score that is received from the OAS, and which may be associated with at least the one keyword. In particular, the quality score may indicate relative performance of at least the one keyword in the paid search results that are generated by the search engine in response to the user search queries.

In some embodiments, the keywords are extracted independently of frequencies of occurrence of the keywords in the product information. However, note that extracting the keywords may involve constructing the keywords based on: terms identified in the product information, attributes extracted from the product information which are associated with the keywords, and/or sources other than the product information.

Furthermore, prior to calculating the performance metrics, the system may dynamically determine an activation condition of one or more of the extracted keywords based on associated numbers of products provided by the entities. For example, an extracted keyword may be ‘active’ if an entity provides more than a predefined number of products that are associated with the extracted keyword. If the dynamically determined activation condition for a given keyword indicates that the given keyword is inactive, subsequent processing of the given keyword may be terminated. However, if the dynamically determined activation condition for the given keyword, which is currently inactive, subsequently indicates that the given keyword is active, subsequent processing of the given keyword may be reactivated.

Additionally, the performance metrics may include a search-engine performance metric. In some embodiments, the performance metric that is independent of the product information includes at least one of: a metric that indicates an association between the given keyword and a probability that a user is shopping for a product; and a metric that indicates a preferred ordering of terms in the given keyword. Moreover, the performance metric that is based on the product information may include at least one of: a grade associated with the given keyword that estimates its profitability when used in the OAS; an estimated quality score that indicates a relative performance of the given keyword in the paid search results that are generated by the search engine in response to the user search queries; an estimate of revenue associated with the given keyword during a visit by a user to a location associated with one of the entities; a product classification associated with the given keyword; and an attribute associated with the given keyword.

In some embodiments, the OAS performance metric includes at least one of: a query volume, which is associated with the given keyword, in a search engine; and a metric of bid competition in the OAS associated with the given keyword.

Furthermore, the estimated viability may be determined based on an estimated revenue per click and an estimated click through rate of an icon (such as a link) on a comparison-shopping engine that is associated with one of the entities which provides a given product. Note that a user may be referred to the comparison-shopping engine in response to the user activating another icon in the paid search results that are generated by the search engine in response to a search query of the user.

Another embodiment provides a method that includes at least some of the operations performed by the system.

Another embodiment provides a computer-program product for use with the system. This computer-program product includes instructions for at least some of the operations performed by the system.

### BRIEF DESCRIPTION OF THE FIGURES

FIG. 1 is a flow chart illustrating a method for publishing keywords for use in an online advertising system (OAS) in accordance with an embodiment of the present disclosure.

FIG. 2 is a flow chart illustrating the method of FIG. 1 in accordance with an embodiment of the present disclosure.

FIG. 3 is a block diagram illustrating a search-engine marketing system in accordance with an embodiment of the present disclosure.

FIG. 4 is a block diagram illustrating a computer system in the search-engine marketing system of FIG. 3 that performs the method of FIGS. 1 and 2 in accordance with an embodiment of the present disclosure.

FIG. 5 is a block diagram illustrating a data structure for use in the computer system of FIG. 4 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In a technique for publishing keywords for use in an online advertising system (OAS), keywords are extracted from product information that is received from entities that provide products. Based on calculated performance metrics associated with the extracted keywords, an estimated viability of the keywords when used in the OAS (such as an estimated profitability) is determined and a subset of the keywords is selected. Then, the selected subset of the keywords is published to the OAS. For example, the selected keywords may be bid on for use in search-engine-based online-advertising campaigns. Note that the performance metrics for a given keyword may include: a performance metric that is independent of the product information, a performance metric that is based on the product information, and/or an OAS performance metric.

By obviating the need for a user (such as an online advertiser or a comparison-shopping engine) to select the keywords, this publishing technique may significantly improve the quality of the keywords that are selected, both from the perspective of their efficacy in attracting paying customers to e-commerce websites and/or comparison-shopping engines, and in terms of their profitability to these entities. Furthermore, this approach may be scalable, thereby allowing millions of keywords to be selected and/or generated, and appropriately evaluated on a time-variant basis (and, thus, addressing the dynamic nature of product information and associated products in online networks such as the Internet). As a consequence, the publishing technique may facilitate: improved commercial activity, enhanced profitability of e-commerce websites and/or comparison-shopping engines, as well as increased customer loyalty.

In the discussion that follows, the entities may include merchants, retailers, resellers and distributors, including online and physical (or so-called ‘brick and mortar’) establishments. Furthermore, a search engine may include a system that retrieves documents (such as files) from a corpus of documents and, more generally, provides search results (including information and/or advertising) in response to user-provided search queries. Additionally, a comparison-shopping engine (such as Become, Inc. of Sunnyvale, Calif.) may include a system that: compares attributes (such as prices and/or features) and reviews of products offered by third parties; and which can identify multiple products in response to keyword-based search queries from users. Note that an OAS may be implemented via a search engine and/or a comparison-shopping engine. In addition, a ‘query’ may refer to a keyword that is analyzed for potential publication to the OAS, or may indicate a user query to a search engine or a comparison-shopping engine that can include multiple keywords.

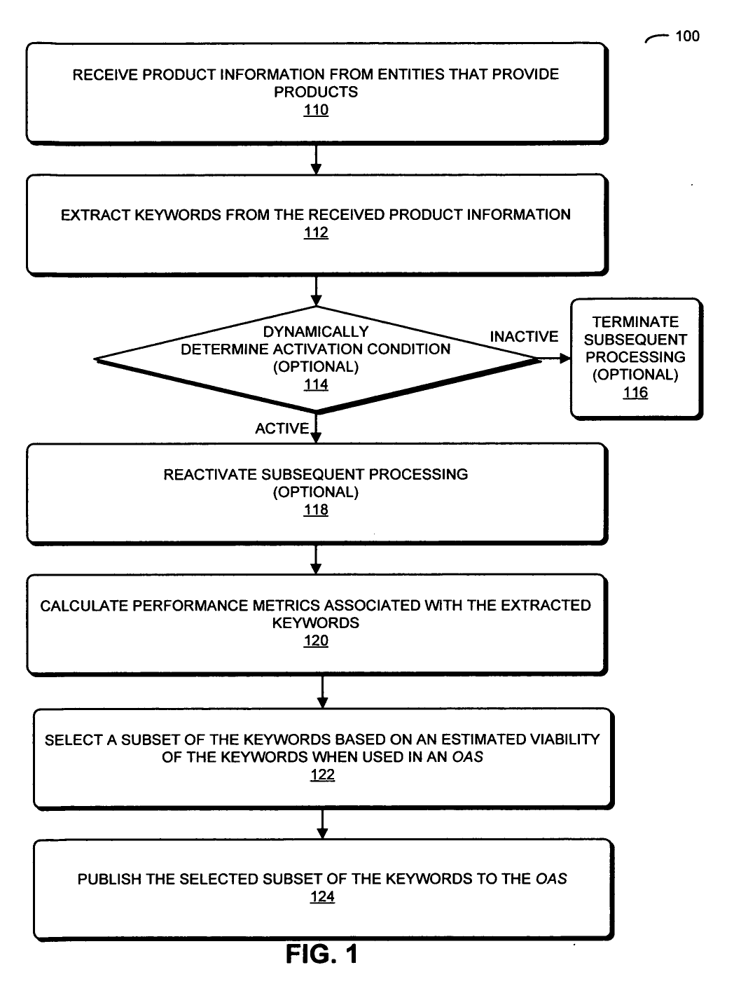

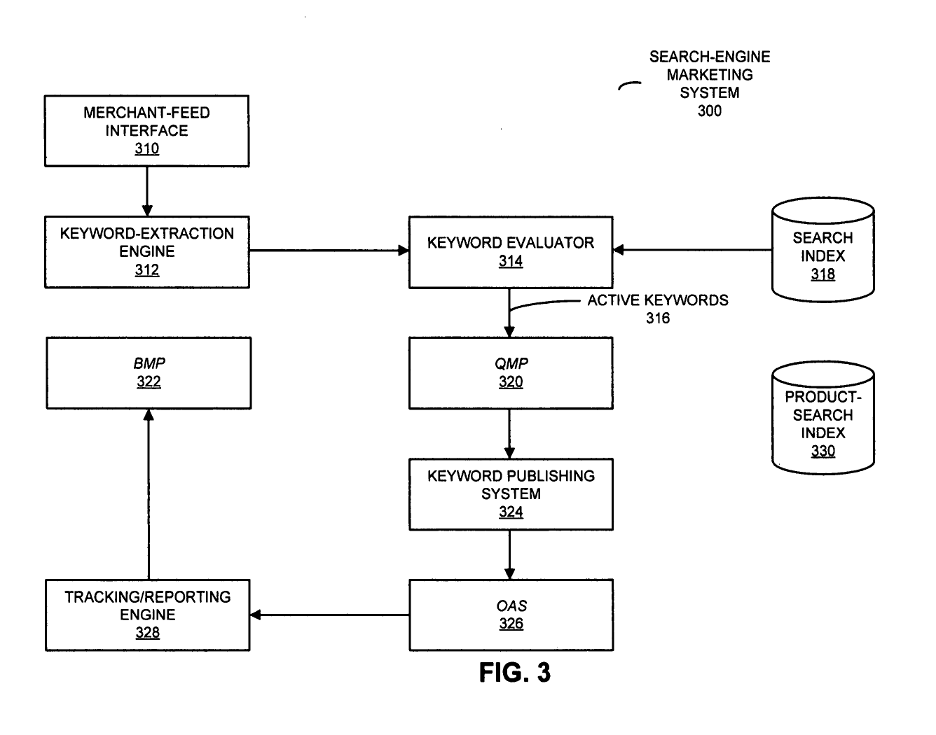

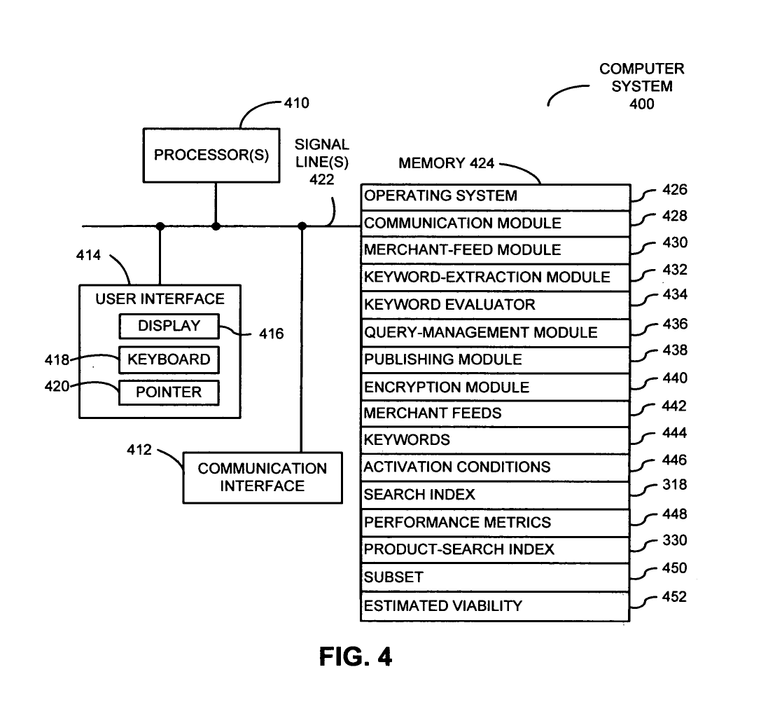

We now describe embodiments of the publishing technique. FIG. 1 presents a flow chart illustrating a method 100 for publishing keywords for use in an OAS, which may be performed by search-engine marketing system 300 (FIG. 3) and/or computer system 400 (FIG. 4). During operation, the system receives product information from entities that provide products (operation 110), and extracts keywords from the received product information (operation 112). In some embodiments, the keywords are extracted independently of frequencies of occurrence of the keywords in the product information (e.g., independently of how many times a given keyword is mentioned in the product information). However, note that extracting the keywords may involve constructing the keywords based on: terms identified in the product information, attributes extracted from the product information which are associated with the keywords, and/or sources other than the product information.

Then, the system calculates performance metrics associated with the extracted keywords (operation 120). The performance metrics for a given keyword may include: a performance metric that is independent of the product information, a performance metric that is based on the product information, and/or an OAS performance metric.

For example, the performance metrics may include a search-engine performance metric. In some embodiments, the performance metric that is independent of the product information includes at least one of: a metric that indicates an association between the given keyword and a probability than a user is shopping for a product (a so-called ‘shop-intent metric’); and a metric that indicates a preferred ordering of terms in the given keyword. Moreover, the performance metric that is based on the product information may include at least one of: a grade associated with the given keyword that estimates its profitability when used in the OAS (and, more generally, an estimate of the viability of the given keyword when used in the OAS); an estimated quality score that indicates a relative performance of the given keyword in the paid search results that are generated by the search engine in response to the user search queries (for example, an indication of the ranking or position in paid search results based on a search query that include the given keyword, as opposed to that associated with other keywords); an estimate of revenue associated with the given keyword during a visit by a user to a location associated with one of the entities (such as a web page or a website associated with one of the entities); a product classification associated with the given keyword (such as ‘consumer electronics’); and an attribute associated with the given keyword (such as a specified characteristic).

In some embodiments, the OAS performance metric includes at least one of: a search query volume, which is associated with the given keyword, in a search engine (e.g., how often the given keyword is showing up in search-engine results); and a metric of bid competition in the OAS associated with the given keyword (e.g., an estimate of the current bid amount for the given keyword or the number of competing bids for the given keyword).

Furthermore, the estimated viability may be determined based on an estimated revenue per click (and, more generally, an estimated revenue per visit) and an estimated click through rate (which is sometimes referred to as a ‘click out rate’) of an icon (such as a link) on a comparison-shopping engine that is associated with one of the entities which provides a given product. Note that a user may be referred to the comparison-shopping engine in response to the user activating another icon in the paid search results that are generated by the search engine in response to a search query of the user. Thus, in effect, the estimated click through rate may include a concatenation (or combination) of the estimated click through rate in the paid search results and the estimated click through rate on the comparison-shopping engine.

Next, the system selects a subset of the keywords based on an estimated viability of the keywords when used in the OAS (operation 122), where the estimated viability is determined using the calculated performance metrics.

Moreover, the system publishes the selected subset of the keywords to the OAS (operation 124). For example, publishing the selected subset of the keywords may involve bidding to be associated with the keywords in paid search results that are generated by a search engine in response to user search queries. Alternatively or additionally, publishing the selected subset of the keywords may involve aggregating groups of keywords in the selected subset (where at least one of the keywords may be assigned to multiple groups of keywords). In these embodiments, a given group of keywords may have a common product classification and a common construction template, which can be used to generate advertising text (or ad-copy) associated with a given keyword in the given group of keywords based on the construction template and one or more attributes associated with the given keyword. Furthermore, at least one of the keywords may be dynamically reassigned from a group of keywords to another group of keywords based on a quality score that is received from the OAS. This quality score may be associated with at least the one keyword, and may indicate the relative performance of at least the one keyword in the paid search results that are generated by the search engine in response to the user search queries.

Furthermore, in some embodiments, prior to calculating the performance metrics, the system may optionally dynamically determine an activation condition of one or more of the extracted keywords based on associated numbers of products provided by the entities (operation 114). For example, an extracted keyword may be ‘active’ if an entity provides or offers more than a predefined or minimum number of products that are associated with the extracted keyword. If the optionally dynamically determined activation condition for a given keyword indicates that the given keyword is inactive, subsequent processing of the given keyword may be optionally terminated (operation 116). However, if the optional dynamically determined activation condition for the given keyword, which is currently inactive, subsequently indicates that the given keyword is active (for example, if an entity now has sufficient products associated with the given keyword), subsequent processing of the given keyword may be optionally reactivated (operation 118).

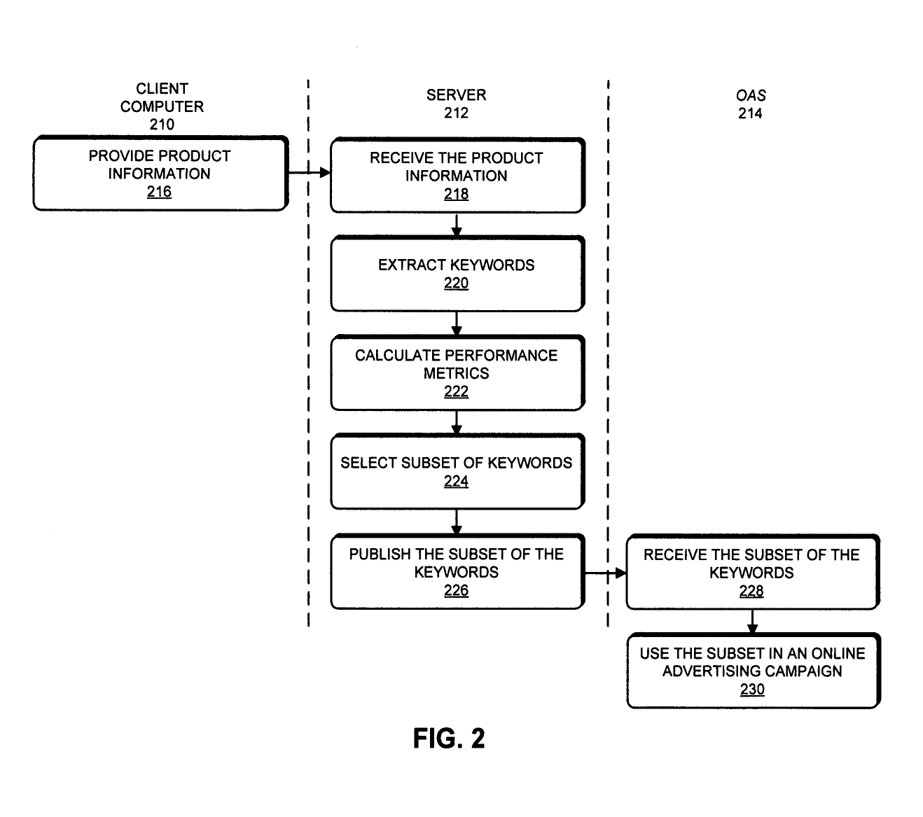

In an exemplary embodiment, the publishing technique is implemented using one or more client computers and at least one server computer, which communicate through a network, such as the Internet (i.e., using a client-server architecture). This is illustrated in FIG. 2, which presents a flow chart illustrating method 100 (FIG. 1). During this method, an entity provides the product information (operation 216) from client computer 210. After receiving the product information from the entity, as well as from numerous other entities not shown (operation 218), server 212 in search-engine marketing system 300 (FIG. 3) extracts the keywords from the received product information (operation 220) and calculates the performance metrics associated with the extracted keywords (operation 222).

Moreover, server 212 selects the subset of the keywords based on the estimated viability of the keywords when used in the OAS using the calculated performance metrics (operation 224). Then, server 212 publishes the selected subset of the keywords to OAS 214 (operation 226). After receiving the published subset (operation 228), OAS 214 may use the subset of the keywords in an online advertising campaign (operation 230). For example, the OAS may have keywords in the subset associated with advertising that is displayed in paid search response on a search engine.

In some embodiments of method 100 (FIGS. 1 and 2) there may be additional or fewer operations. Moreover, the order of the operations may be changed, and/or two or more operations may be combined into a single operation.

In an exemplary embodiment, entities, such as merchants, submit catalogs that include product information about millions of products offered by the entities. These catalogs may be processed by a keyword-generation engine. Furthermore, the products in the catalogs may be classified according to an internal taxonomy. In some embodiments, a one-time manual process specifies regular expression rules that can be used to extract attributes for a taxonomy node, as well as how to combine the extracted attributes to produce or generate keywords. Alternatively or additionally, the product title (and, more generally, the product information) in the catalogs may be processed to generate n-grams that include n consecutively occurring tokens or words (where n may be between 1 and 5). Note that a keyword typically includes multiple tokens.

In some embodiments, new keywords, as well as keywords that are already active in an OAS, are evaluated (for example, daily) to test for a minimum number or a threshold of product results (such as 3-5 product results) associated with a given keyword using a customized fast-search index. If the number of product results associated with a given keyword is below the threshold, this keyword may be paused or de-activated (i.e., subsequent keyword processing in the publishing technique may be disabled). However, when the number of product results exceeds the threshold, the given keyword may be re-enabled or activated (i.e., subsequent keyword processing in the publishing technique may be enabled).

Keywords that pass the minimum-results test may then go through the next operation of parameter collection, including calculation of internal and external performance factors or metrics. In particular, internal factors may include keyword-specific metrics that are computed using machine learning techniques (e.g., the shop-intent metric) or from product-search results (e.g., the expected revenue per click through on the comparison-shopping engine, keyword classification(s), associated attributes, etc.). Furthermore, external factors may include keyword search volume, bid popularity, etc. Some or all of these factors may be combined using machine learning techniques (e.g., regression models) to produce an estimate of the expected revenue per user visit to a comparison-shopping engine, as well as an estimate of a resulting merchant conversion (e.g., whether or not the user will subsequent complete a transaction and purchase a product from a merchant). These two metrics may be used to determine the subset of the keywords that are published to the OAS.

Note that once the expected revenue per user visit is determined, the starting bids (or bid amounts) of keywords on search engines can then be determined, along with a statistical expectation as to which of the keywords are likely to perform profitably. Moreover, the advertising campaign to which the keywords belong may be determined by their taxonomy or classification mapping(s), and the group of keywords or the advertising group within a given campaign may determined by the attributes associated with a particular search query and the text similarity between keywords. Furthermore, multiple targeted ad-copies or advertising text may be generated based on keyword attributes and a common construction template associated with the group of keywords. For example, using the construction template “Compare prices for <brand><product-type> with <attribute value><attribute name>”, the advertising text “Compare prices for Sony lcd tv with 1080p resolution” can be generated.

Thus, the publishing technique can: facilitate keyword selection or generation; estimate keyword profitability; classify or group keywords, and generate advertising text. All of which, can significantly improve the operation and profitability of e-commerce websites and comparison-shopping engines.

Note that in an exemplary embodiment there are five million active keywords in a comparison-shopping search index, with 1000 classifications and approximately 50 groups of keywords (which are sometimes referred to as ‘advertising groups’).

Furthermore, while server 212 is illustrated in FIG. 2 as a single computing device, in some embodiments it may include multiple networked computing devices that can be divided into master server(s) and client computers. For example, there may be two master servers that are coupled to search-engine marketing product-search machines in search-engine marketing system 300 (FIG. 3). The master servers may run perpetually (for example, they may only be restarted once per day to obtain updates). In some embodiments, the performance metric computations (such as keyword-specific, search-result dependent, etc.) that are possible at the time of querying a particular keyword are performed by a given master server.

In these embodiments, there may be dozens of client-computer deployments for various purposes. These client computers may start, stream in queries from an input source, send them to a master server (for example, via an eXtensible Mark-up Language or XML over a network socket) and receive an XML response. These results may then be parsed and stored. A notable exception may include the main query or keyword evaluation process, which may execute continuously.

Note that queries can be input to a client computer via: a console, a file, a database and/or web-interface. Similarly, results can be output to: a console, a file, a database, a web-interface and/or the Xwindow system. In general, the client computers may only be responsible for: queries, results, inputs and outputs. Therefore, the ‘intelligence’ in this architectural configuration may be centered in the master servers (which are denoted by server 212 in FIG. 2).

This client-server approach may facilitate simplified updates. For example, updates to training data or to analysis techniques may only need to be deployed to the master servers, even though there may be dozens of client-computer processes that use the calculated evaluation metrics. In this way, the client computers can obtain the most up-to-date query (or keyword) evaluation information.

Moreover, this approach may simplify maintenance. For example, in order to stop client-computer keyword evaluations, only the master servers may need to be stopped (as opposed to halting jobs on multiples machines).

Furthermore, the client-server architecture may facilitate query traffic control. This may allow the number of concurrent requests for query (or keyword) evaluation, which the product-search system can receive, to be limited. This may be useful because high-query volumes can cause timeouts during product search, which can result in incorrect or inaccurate query (or keyword) evaluation.

Additionally, this architectural approach may simplify set up of the client computers. For example, training set data, internationalization files, dictionaries, etc. may only need to be set up on the master servers; client computers for evaluating queries from different sources or for different purposes can be setup using one or more configuration file(s).

We now describe embodiments of a search-engine marketing system 300 and a computer system 400 (FIG. 4) and their use. FIG. 3 presents a block diagram illustrating a search-engine marketing system 300 that performs method 100 (FIGS. 1 and 2). This search-engine marketing system includes: merchant-feed interface 310 that receives product information (such as titles and descriptions); a keyword-extraction engine 312 that extracts and/or generates keywords (for example, using n-grams, extracted attributes and construction templates); and a keyword evaluator 314 that determines the activation conditions of the keywords (including active keywords 316) using a fast search index 318 that provides the number of product results for a given product.

Furthermore, search-engine marketing system 300 includes a query (or keyword) management platform (QMP) 320. QMP 320 interacts with bid management platform (BMP) 322 (which manages bid amounts), keyword publishing system 324 (which publishes the subset of keywords to OAS 326) and tracking/reporting engine 328 (which compiles statistics and performance-history information for use in generating and publishing the keywords) in search-engine marketing system 300. QMP 320 manages keyword generation, evaluation and publication to ad-networks or search engines. This evaluation includes: new keywords, existing keywords (which are already used on ad-networks), and old keywords that have been paused or are inactive on ad-networks.

In some embodiments, the product-search workflow in search-engine marketing system 300 may involve the following operations. Merchant feeds may be received from entities. Note that a merchant feed may be a file (which may be tab separated) that includes: product titles, product descriptions, product prices, merchant categories, merchant bid(s), and/or additional fields. These files may be submitted by merchants periodically, such as and when product information updates. Note that in a cost-per-lead (or click) model, a merchant-bid is the amount that merchants pay the e-commerce website or the comparison-shopping engine for sending a click (i.e. a potential customer) to the merchant site.

The feeds typically go through a normalization process, after which all the ‘active’ feeds are uploaded to a database for building a product-search index 330 on a daily basis that include all the products (and, thus, has the same search results as the e-commerce websites). Note that, the active feeds may be exported from merchant-feed interface 310 as one or more large text files that include all of the fields that will be indexed for online product search. Once the feed is exported, it may start a chain of operations for keyword extraction and evaluation.

Notably, keyword-extraction engine 312 may use the feed to generate keywords for search-engine-marketing campaigns. In some embodiments, keywords are generated by extracting n-grams from titles. In particular, titles may be tokenized into segments separated by selected stop words (for example, common tokens or words, such as ‘with,’ ‘for,’ etc.). From each segment, tokens that are part of common phrases (such as two or three token keywords) may be marked or identified as an inseparable unit (such as ‘high speed’ or ‘digital camera’). Then, these segments may be divided into two or three gram adjacent tokens or units. Note that an n-gram may have to occur a certain number of times in the feed in order for it to be output as a potential keyword for use in search-engine marketing.

Alternatively or additionally, keywords may be generated based on attributes. In particular, a product may be classified based on a category tree (or taxonomy), which is determined by combining merchant-provided category and machine learning techniques. Moreover, regular expression rules may extract attributes from the title and description text after a product has been assigned to a particular taxonomy node(s). Note that attributes may include properties that are specific to products in a category. For example, if the product belongs to an ‘lcd tv’ taxonomy node, its attributes may include: brand, resolution, screen size, response time, etc. Then, keywords may be generated by combining attributes using heuristic rules, e.g., brand+resolution+product-type.

In some embodiments, keywords are also obtained from other sources, such as by crawling web pages or websites. In these embodiments, a web-crawler (not shown) downloads web pages from a network (such as the Internet) by following links to explore web pages that contain useful shopping content. Then, each web page that is crawled may be assigned a shopping score (for example, based on the links to a web page from other web pages, an assessment may be made of the relevance of the web page to shopping for a given product, such as a printer). Furthermore, keywords may be extracted by normalizing anchor text (such as a short text description of a given web page) on the other linked web pages that point to high shop-content web pages, as well as anchor text contained within those web pages. Note that, in some embodiments, keywords may be added manually or may be provided by third-party sources.

Because the keywords are published to ad-networks primarily to drive traffic to product-search, it is often useful that the landing web page provided by a comparison-shopping engine have sufficient products to create a good user experience and revenue-generating engagement on the website. Note that the landing web page may be the uniform resource locator (URL) submitted along with a query submission, and may be the web page shown to users when they click on a query advertisement displayed on a comparison-shopping engine or a search engine.

Furthermore, changes in the product result set may be gradual due to seasonal changes, or may be abrupt as a merchant's product stock changes or due to weekly feed submission changes. Because the product count can significantly impact the number of results shown for a product and hence the conversion metric for a keyword, keyword evaluator 314 may determine the activation condition of the keywords, thereby preemptively pausing certain keywords in online marketing campaigns so that its performance history is not impacted. As noted previously, once a keyword has sufficient number of product results, it may be un-paused again (i.e., it may be included in active keywords 316).

To facilitate this aspect of the keyword evaluation, a search index 318 may be build from the merchant feed. Unlike regular search programs that incorporate several rankings and token proximity calculations, search index 318 may be specialized. In particular, this customized search index may be optimized to speed the analysis to determine if the number of product results for a query or keyword exceeds a threshold. This optimized search index may be able to process several million queries or keywords per hour. Note that keywords that have been paused in near past may be run through search index 318 to check if they have sufficient results to be un-paused or reactivated. Also, note that the keywords that are currently ‘live’ or active in search-engine marketing may be evaluated for minimum product-result count, and may be paused if they don't meet the threshold criterion.

All of the keywords that meet the minimum product-results criterion then go through full keyword evaluation by QMP 320. Full keyword evaluation typically involves keyword-specific, product-independent evaluation, and evaluation based on query (or keyword) and landing-web-page relation.

Thus, a wide-variety of performance metrics may be used to evaluate keywords. The product-independent evaluation metrics may include shop-intent and token order within a keyword. Because keywords are purchased to convert users on e-commerce websites, determining the shop-intent of keywords may be useful to drive shopping qualified traffic to a comparison-shopping engine. For example, a keyword such as ‘driving directions’ or ‘online pie recipes’ may be less likely to turn into conversion events (i.e., they may have poor click-through rates), as opposed to product-related queries or keywords. To facilitate this analysis, a training set of keywords (such as one with 10,000 keywords) may be created based on the performance of keywords on a comparison-shopping engine.

In some embodiments, the shop-intent of a keyword can be computed using machine learning techniques such as a Naïve Bayesian or Fisher classifier. In these techniques, a keyword may be broadly classified into two categories: shopping related and unrelated to shopping. Then by Bayes' theorem,

$$Pr ( Category \vert Keyword ) = Pr ( Keyword \vert Category ) \cdot \frac{Pr ( Category )}{Pr ( Keyword )} . \qquad ( 1 )$$

Note that the probability, Pr(Keyword|Category) may be computed by assuming that the probabilities are independent of each other, and multiplying the weighted probabilities (Pw) of each token or word belonging to that category. Furthermore, Pr(Category) may be the number of keywords in that category divided by the total number of keywords. Note that computing Pr(Keyword) may not required because shopping relatedness of a keyword is usually based on a threshold of Pr(Shopping|Keyword) divided by Pr(Non-shopping|Keyword), i.e., the absolute probability may not be required.

Another technique uses the Fisher classifier to determine the shop intent of a keyword. In the Fisher-classifier technique, the probability of two categories for each token in the keyword are calculated and tested to see if the set of probabilities is more or less likely than a random set. If the probabilities of the token are independent and random, they would fit a chi-square distribution; otherwise they are more likely to belong to a particular category. Note that the inverse chi-square function may return a high combined probability if several tokens or words have a high weighted probability (P_{w}(i)) for the given category. In particular,

$${P}_{C} ( Category ) = {C}^{- 1} ( - 2 ln {\prod }_{i = 0}^{n} {P}_{W} ( i ) , 2 n ) , \qquad ( 2 )$$

where Pc, the combined probability, is the inverse chi-square function, C⁻¹ is a normalization and n is number of tokens (or words) in the keyword. In this case, the shop-intent metric may be computed as

[1+Pr(Shopping)−Pr(Nonshopping)]2.

Note that in this analysis, a new keyword may initially be given a neutral probability (such as 0.5). However, certain types of keywords, such as alphanumeric keywords may be given a higher value. In general, in this analysis it may be more important to identify keywords with low shop-intent metrics (which can then be excluded) than keywords with high shop-intent metrics.

Keywords may also be evaluated based on token or word ordering. While the keyword evaluation may not make any assumptions about the source of the keywords or the generation process, the popular ordering of keywords may be useful in creating meaningful ad-copy, such as a snippet of text that is displayed on search-engine websites that can have keywords dynamically inserted. Ad-copy can impact the click through rate, as well as product relevancy, because keyword-search result scoring often depends on the order of keywords.

In order to determine the correct keyword ordering, a keyword may be submitted to a corpus of documents (not shown) that contains billions of web pages. This corpus size may be large enough to provide a high degree of confidence in the results, as opposed to product-search index 330, which may be several orders of magnitude smaller. In some embodiments, the ordering of tokens or words within keywords is determined by querying the corpus with a keyword that is to be evaluated. Then, within each title and description, all the occurrences and locations of keyword tokens (which may not be contiguous) may be identified. Next, based on a proximity weighted-ordering frequency, the final keyword order may be determined. Note that proximity may be the text-token distance between the last and the first token in a given order.

The product-dependent metrics may include a keyword grade. For this performance metric, keywords may first be broadly classified to determine their viability in search-engine marketing. This operation may, effectively, be a binary filter that weeds out bidding on keywords that have a high probability of being unprofitable. This analysis may be based on a first training dataset of keywords that performed poorly after traffic acquisition and sending the traffic to a query landing web page, and a second set of profitable keywords. In this analysis, a decision tree, such as one generated using Classification and Regression Analysis (CART), may be used to determine the grade of a keyword. The evaluated features in the decision tree may include: whether the dominant results corresponding to a query include media (such as books, movies, video, etc.); the number of exact product match results for the query; the weighted-average bid amount of products on the results web page; and the entropy of taxonomy mapping of products on the web page. For this last feature, note that each product belongs to or may be assigned to a taxonomy node (or a product classification).

If X is a set of product classifications on a results web page, with probability {x1, x2, . . . , xₙ}, taxonomy entropy, H(X) may be defined as

$$H ( X ) = - {\sum }_{x ∋ X} p ( x ) \cdot log ( p ( x ) ) , \qquad ( 3 )$$

where p(x) equals taxonomy count xᵢ divided by the total number of products on the landing web page.

Another product-dependent performance metric is the estimated revenue per click (or the estimated revenue per visit) and, more specifically, the estimated average revenue per click on a comparison-shopping engine. This can be computed using a click-through rate model, with clicks at the top-most rank normalized to 1. This model may be determined by aggregating a click distribution versus item rank at a product-category level. The resulting normalized curve may be modeled using a power-law regression (r^{-α}), where r is the rank of an item and a controls the decay of power function. Note that different product categories typically have different power-law curves, which are denoted in aggregate as category-aggregated click-through-rate (CTR) models.

The estimated revenues per click (eRPC) over n results on the landing web page may be the weighted mean of the merchant bids (BID), which are paid to the comparison-shopping engine, using the CTR models. In particular,

$$e R P C = \frac{{\sum }_{i = 1}^{n} C T {R}_{i} \cdot B I {D}_{i}}{{\sum }_{i = 1}^{n} C T {R}_{i}} , \qquad ( 4 )$$

where i is the rank on the landing web page.

Furthermore, another product-dependent performance metric is the keyword classification. Keyword classification may be based on a majority voting rule of product taxonomy mapping for the first web page of results. If there exists a taxonomy identifier to which more than 50% of the products map, it may be used as the identifier for a keyword.

However, if no such majority taxonomy exists, then a different technique may be used. In this case, the keyword may be mapped to the deepest taxonomy node in a classification tree such that the category entropy of the web page is below a set threshold (for example, a threshold of 0.9 with normalized entropy between 0 and 1).

An additional product-dependent performance metric is keyword attributes. In particular, after each product is classified to a node in a classification taxonomy tree, attributes may be extracted from the product text (title, description, etc.) using predefined regular expression rules. Examples of attributes for a liquid-crystal television include: brand, screen size, response time, resolution, etc.

Note that attributes for a keyword may be determined in several ways. For example, after the keyword is classified to a taxonomy node, attributes may be extracted using regular expression rules. Alternatively or additionally, the highest scoring attributes from the top product search results (such as the top 50) may be used to assign keyword attributes. In particular, product attribute scores may be computed from their weighted occurrence using an exponentially reducing weight factor that is a function of the product rank. For example, the weight factor may vary between 1 for the product at the top of the ranking to 0.01 for the 50^{th} product in the ranking.

In addition to the aforementioned performance metrics, in some embodiments external performance metrics are used (such as search-engine performance metrics). For example, the keyword traffic, i.e., a traffic volume indicator for a query that includes a keyword, may be used. Alternatively or additionally, keyword bid competition or bid popularity for a query that includes a keyword may be used. These external performance metrics may be provided by sources external to or other than the comparison-shopping engine or the affiliated merchant e-commerce websites.

The determined performance metrics can be used by QMP 320 to estimate conversion on a comparison-shopping website (i.e., the expected click-out rate). In particular, using user clicks, the conversion on the comparison-shopping website with product-search results may be based on a conversion-per-click (CPC) model. For a keyword that is bid on one or more ad-networks (such as a search engine), the total revenue obtained per visit equals the number of clicks by users multiplied by the average CPC rate. Estimating the user click-through or click-out rate (COR) can be used to determine: which keywords are likely to succeed in ad-marketing on ad-networks; and a start bid.

The estimated click-out rate (eCOR) can be determined based on a feature set of historical training data. These features may depend on: the keywords themselves, product-search results and relevancy, and/or external indicators (such as bid popularity). In an exemplary embodiment, the merchant COR may vary between 0.1 and 0.6 as shop intent varies between 0 and 0.95. Other keyword-specific metrics may include the number of tokens in a keyword and the bid popularity for keywords in a specific taxonomy node. For example, the bid popularity may vary between 0.05 and 0.7 as the merchant COR varies between 0 and 11. However, the Adsense® COR varies between 0.05 and 0.2 as the bid popularity may vary between 0.05 and 0.7.

Furthermore, product-specific factors, such as the number of product results, the weighted average relevancy, etc., may be considered. Thus, the total COR (merchant+Adsense®) as a function of the number of product results for a particular ad-campaign may have a peak total COR of 0.8 for 1000 product results.

Note that these factors may be combined together using a regression model to compute

$$eCOR = C + {\sum }_{i} {w}_{i} {x}_{i} , \qquad ( 5 )$$

where C is a constant and wᵢ is the weight for a feature metric xᵢ determined by the regression model.

Note that the actual COR for each individual keyword can vary significantly from the estimated value, for example, from week to week. Because dominant keywords drive a majority of the traffic, the remaining traffic may be divided among a very large number of keywords (on the order of millions). For these keywords, the traffic volume often may not be a statistically significant measure of the actual COR. Therefore, eCOR can be an unreliable metric on a per-keyword basis. However, by aggregating over a few hundred keywords, and using the measured variance or standard deviation, a threshold for those keywords to publish can be determined.

Once the keyword performance metrics are computed, including the estimated performance (eRPC×eCOR), the estimated traffic volume, and the estimated bid competition, a keyword may be eligible for submission or publishing using simple business rules. In some embodiments, the business rules include the landing web-page performance and merchant conversions. In the case of the landing web-page performance, in general the COR may be the driving criteria of whether a keyword can succeed. Based on a comparison of the historical eCOR and the measured COR of a batch of keywords and an acceptable level of risk, the eCOR can be specified.

Furthermore, at a high level, some properties of keywords and the product web page tend to favor merchant conversions. These features may be extracted by measuring conversions at the merchant website and segmenting keyword properties. For example, some merchants may provide feedback to the comparison-shopping engine indicating that certain keywords did not perform well (e.g., did not result is sales), so these keywords may not be published. Alternatively, if no one else is bidding on a given keyword on a search engine or ad-network, then this keyword may not be published.

Note that the information and/or the additional information in search-engine marketing system 300 may be stored at one or more locations in search-engine marketing system 300 (i.e., locally or remotely). Moreover, because this data may be sensitive in nature, it may be encrypted.

FIG. 4 presents a block diagram illustrating a computer system 400 in search-engine marketing system 300 (FIG. 3) that performs method 100 (FIGS. 1 and 2). Computer system 400 includes one or more processing units or processors 410, a communication interface 412, a user interface 414, and one or more signal lines 422 coupling these components together. Note that the one or more processors 410 may support parallel processing and/or multi-threaded operation, the communication interface 412 may have a persistent communication connection, and the one or more signal lines 422 may constitute a communication bus. Moreover, the user interface 414 may include: a display 416, a keyboard 418, and/or a pointer 420, such as a mouse.

Memory 424 in computer system 400 may include volatile memory and/or non-volatile memory. More specifically, memory 424 may include: ROM, RAM, EPROM, EEPROM, flash memory, one or more smart cards, one or more magnetic disc storage devices, and/or one or more optical storage devices. Memory 424 may store an operating system 426 that includes procedures (or a set of instructions) for handling various basic system services for performing hardware-dependent tasks. Memory 424 may also store procedures (or a set of instructions) in a communication module 428. These communication procedures may be used for communicating with one or more computers and/or servers, including computers and/or servers that are remotely located with respect to computer system 400.

Memory 424 may also include multiple program modules (or sets of instructions), including: a merchant-feed module 430 (or a set of instructions), a keyword-extraction module 432 (or a set of instructions), keyword evaluator 434 (or a set of instructions), query-management module 436 (or a set of instructions), publishing module 438 (or a set of instructions), and/or encryption module 440 (or a set of instructions). Note that one or more of these program modules (or sets of instructions) may constitute a computer-program mechanism.

During operation, merchant-feed module 430 may receive merchant feeds 442, including product information. Then, keyword-extraction module 432 may extract and/or generate keywords 444, and keyword evaluator 434 may determine activation conditions 446 of keywords 444 using search index 318.

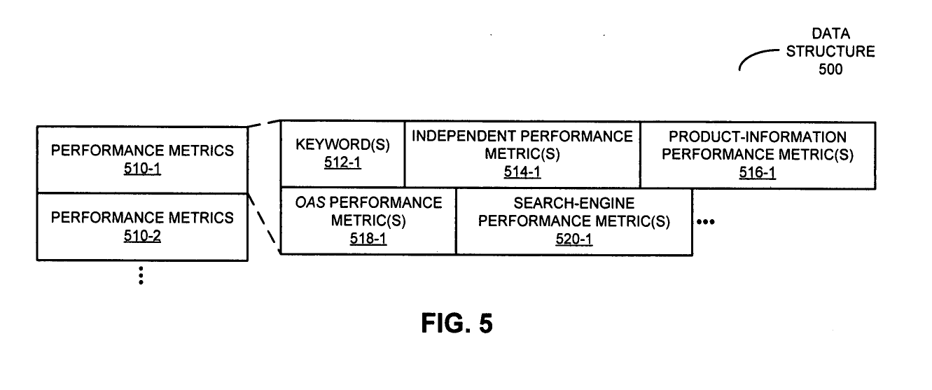

Next, query-management module 436 may calculate performance metrics 448 associated with keywords 444 using information in merchant feeds 442, product-search index 330, etc. As shown in FIG. 5, which presents a block diagram illustrating a data structure 500 for use in computer system 400 (FIG. 4), the performance metrics, such as performance metrics 510-1, may include: a keyword(s) 512-1, a performance metric(s) that is independent of the product information (a so-called independent performance metric 514-1), a performance metric(s) that is based on the product information (a so-called product-information performance metric 516-1), an OAS performance metric(s) 518-1; and/or a search-engine performance metric(s) 520-1.

Referring back to FIG. 4, query-management module 436 may select a subset 450 of the keywords based on an estimated viability 452 (such as an estimated profitability) of the keywords when used in the OAS using the performance metrics 448. Furthermore, publishing module 438 may publish subset 450 to the OAS for use in an online advertising campaign (such as one on a search engine and/or a comparison-shopping engine).

Because the aforementioned information may be sensitive in nature, in some embodiments at least some of the data stored in memory 424 and/or at least some of the data communicated using communication module 428 is encrypted using encryption module 440.

Instructions in the various modules in memory 424 may be implemented in: a high-level procedural language, an object-oriented programming language, and/or in an assembly or machine language. Note that the programming language may be compiled or interpreted, e.g., configurable or configured, to be executed by the one or more processors 410.

Although computer system 400 is illustrated as having a number of discrete items, FIG. 4 is intended to be a functional description of the various features that may be present in computer system 400 rather than a structural schematic of the embodiments described herein. In practice, and as recognized by those of ordinary skill in the art, the functions of computer system 400 may be distributed over a large number of servers or computers, with various groups of the servers or computers performing particular subsets of the functions. In some embodiments, some or all of the functionality of computer system 400 may be implemented in one or more application-specific integrated circuits (ASICs) and/or one or more digital signal processors (DSPs).

Computers and servers in search-engine marketing system 300 (FIG. 3) and/or computer system 400 may include one of a variety of devices capable of manipulating computer-readable data or communicating such data between two or more computing systems over a network, including: a personal computer, a laptop computer, a mainframe computer, a portable electronic device (such as a cellular phone or PDA), a server and/or a client computer (in a client-server architecture). Moreover, these devices may communicate over a network, such as: the Internet, World Wide Web (WWW), an intranet, LAN, WAN, MAN, or a combination of networks, or other technology enabling communication between computing systems.

Search-engine marketing system 300 (FIG. 3), computer system 400 (FIG. 4) and/or data structure 500 may include fewer components or additional components. Moreover, two or more components may be combined into a single component, and/or a position of one or more components may be changed. In some embodiments, the functionality of search-engine marketing system 300 (FIG. 3) and/or computer system 400 (FIG. 4) may be implemented more in hardware and less in software, or less in hardware and more in software, as is known in the art.

While the preceding discussion illustrated the use of the publication technique for publishing keywords for use in an OAS, in other embodiments these techniques may be used to select keywords or phrases for use in a wide variety of advertising or marketing campaigns, including those that are implemented in convention print media (such as magazines, newspapers, coupons, etc.). Furthermore, in some embodiments the published keywords may be individual-specific, i.e., the subset of keywords may be used to implement a tailored and/or targeted ad-campaign that focuses on a specific individual. Such an ad-campaign may occur dynamically, for example, based on the location of an individual using a portable electronic device (e.g., a cellular telephone).

The foregoing description is intended to enable any person skilled in the art to make and use the disclosure, and is provided in the context of a parti-cular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-implemented method for publishing keywords for use in an online advertising system (OAS), the method comprising:
receiving, at the computer, product information from entities that provide products;
extracting keywords from the received product information;
calculating performance metrics associated with the extracted keywords, wherein the performance metrics for a given keyword include at least: a performance metric that is independent of the product information, a performance metric that is based on the product information, and an OAS performance metric;
selecting a subset of the keywords based on an estimated viability of the keywords when used in the OAS, wherein the estimated viability is determined using the calculated performance metrics; and
publishing the selected subset of the keywords to the OAS.

2. The method of claim 1, wherein publishing the selected subset of the keywords involves bidding to be associated with the keywords in paid search results that are generated by a search engine in response to user search queries.

3. The method of claim 1, wherein publishing the selected subset of the keywords involves aggregating groups of keywords in the selected subset; and
wherein a given group of keywords have a common product classification and a common construction template, which can be used to generate advertising text associated with a given keyword in the given group of keywords based on the construction template and one or more attributes associated with the given keyword.

4. The method of claim 3, wherein at least one of the keywords is assigned to multiple groups of keywords.

5. The method of claim 3, wherein at least one of the keywords is dynamically reassigned from a group of keywords to another group of keywords based on a quality score that is received from the OAS;
wherein the quality score is associated with at least the one keyword; and
wherein the quality score indicates relative performance of at least the one keyword in paid search results that are generated by a search engine in response to user search queries.

6. The method of claim 1, wherein the keywords are extracted independently of frequencies of occurrence of the keywords in the product information.

7. The method of claim 1, wherein, prior to calculating the performance metrics, the method further comprises dynamically an determining activation condition of one or more of the extracted keywords based on associated numbers of products provided by the entities; and
wherein, if the dynamically determined activation condition for a given keyword indicates that the given keyword is inactive, subsequent processing of the given keyword in the method is terminated.

8. The method of claim 7, wherein, if the dynamically determined activation condition for the given keyword, which is currently inactive, subsequently indicates that the given keyword is active, subsequent processing of the given keyword in the method is reactivated.

9. The method of claim 1, wherein extracting the keywords involves constructing the keywords based on terms identified in the product information, attributes extracted from the product information which are associated with the keywords, and sources other than the product information.

10. The method of claim 1, wherein the performance metrics include a search-engine performance metric.

11. The method of claim 1, wherein the performance metric that is independent of the product information includes at least one of: a metric that indicates an association between the given keyword and a probability than a user is shopping for a product; and a metric that indicates a preferred ordering of terms in the given keyword.

12. The method of claim 1, wherein the performance metric that is based on the product information includes at least one of: a grade associated with the given keyword that estimates its profitability when used in the OAS; an estimated quality score that indicates a relative performance of the given keyword in paid search results that are generated by a search engine in response to user search queries; an estimate of revenue associated with the given keyword during a visit by a user to a location associated with one of the entities; a product classification associated with the given keyword; and an attribute associated with the given keyword.

13. The method of claim 1, wherein the OAS performance metric includes at least one of: a query volume, which is associated with the given keyword, in a search engine; and a metric of bid competition in the OAS associated with the given keyword.

14. The method of claim 1, wherein the estimated viability is determined based on an estimated revenue per click and an estimated click through rate of an icon on a comparison-shopping engine that is associated with one of the entities which provides a given product; and
wherein a user is referred to the comparison-shopping engine in response to the user activating an icon in paid search results that are generated by a search engine in response to a search query of the user.

15. A computer-program product for use in conjunction with a system, the computer-program product comprising a non-transitory computer-readable storage medium and a computer-program mechanism embedded therein, to publish keywords for use in an OAS, the computer-program mechanism including:
instructions for receiving product information from entities that provide products;
instructions for extracting keywords from the received product information;
instructions for calculating performance metrics associated with the extracted keywords, wherein the performance metrics for a given keyword include at least: a performance metric that is independent of the product information, a performance metric that is based on the product information, and an OAS performance metric;
instructions for selecting a subset of the keywords based on an estimated viability of the keywords when used in the OAS, wherein the estimated viability is determined using the calculated performance metrics; and
instructions for publishing the selected subset of the keywords to the OAS.

16. The computer-program product of claim 15, wherein publishing the selected subset of the keywords involves aggregating groups of keywords in the selected subset; and
wherein a given group of keywords have a common product classification and a common construction template, which can be used to generate advertising text associated with a given keyword in the given group of keywords based on the construction template and one or more attributes associated with the given keyword.

17. The computer-program product of claim 15, wherein the keywords are extracted independently of frequencies of occurrence of the keywords in the product information.

18. The computer-program product of claim 15, wherein, prior to calculating the performance metrics, the computer-program mechanism includes instructions for dynamically determining an activation condition of one or more of the extracted keywords based on associated numbers of products provided by the entities; and
wherein, if the dynamically determined activation condition for a given keyword indicates that the given keyword is inactive, the computer-program mechanism includes instructions for terminating subsequent processing of the given keyword.

19. The computer-program product of claim 18, wherein, if the dynamically determined activation condition for the given keyword, which is currently inactive, subsequently indicates that the given keyword is active, the computer-program mechanism includes instructions for subsequently reactivating processing of the given keyword.

20. The computer-program product of claim 15, wherein extracting the keywords involves constructing the keywords based on terms identified in the product information, attributes extracted from the product information which are associated with the keywords, and sources other than the product information.

21. The computer-program product of claim 15, wherein the estimated viability is determined based on an estimated revenue per click and an estimated click through rate of an icon on a comparison-shopping engine that is associated with one of the entities which provides a given product; and
wherein a user is referred to the comparison-shopping engine in response to the user activating an icon in paid search results that are generated by a search engine in response to a search query of the user.

22. A system, comprising:
a processor;
memory; and
a program module, wherein the program module is stored in the memory and configurable to be executed by the processor to publish keywords for use in an OAS, the program module including:
instructions for receiving product information from entities that provide products;
instructions for extracting keywords from the received product information;
instructions for calculating performance metrics associated with the extracted keywords, wherein the performance metrics for a given keyword include at least: a performance metric that is independent of the product information, a performance metric that is based on the product information, and an OAS performance metric;
instructions for selecting a subset of the keywords based on an estimated viability of the keywords when used in the OAS, wherein the estimated viability is determined using the calculated performance metrics; and
instructions for publishing the selected subset of the keywords to the OAS.
